(19) United States
(12) Patent Application Publication
(10) Pub. No.: US 2026/0369474 A1
(43) Pub. Date: Nov. 19, 2026

(54) METHOD FOR MANUFACTURING CERAMIC SHEET STACK AND METHOD FOR MANUFACTURING MULTILAYER CERAMIC ELECTRONIC COMPONENT

(71) Applicant: KYOCERA Corporation, Kyoto-shi, Kyoto (JP)

(72) Inventors: Koshiro SUGIMOTO, Aira-shi, Kagoshima (JP); Yutaka TOKUDA, Kirishima-shi, Kagoshima (JP); Itaru HISADA, Kirishima-shi, Kagoshima (JP)

(73) Assignee: KYOCERA Corporation, Kyoto-shi, Kyoto (JP)

(21) Appl. No.: 19/139,963

(22) PCT Filed: Dec. 8, 2023
(86) PCT No.: PCT/JP2023/044115

§ 371 Date: Jun. 17, 2025

(30) Foreign Application Priority Data
Dec. 19, 2022 (JP) 2022-202533

(51) Int. Cl. H01G 4/005; H01G 4/12; H01G 4/30; H01G 13/00

(52) U.S. Cl. CPC H01G 4/005; H01G 4/12; H01G 4/30; H01G 13/006

(57) ABSTRACT

A method for manufacturing a ceramic sheet stack includes forming a first ceramic sheet on a carrier film, printing, by gravure printing, multiple first electrode patterns and multiple first positioning patterns sequentially on the first ceramic sheet, drying the first electrode patterns, forming a second ceramic sheet, printing, by gravure printing, multiple second electrode patterns and multiple second positioning patterns sequentially on the second ceramic sheet, and aligning, based on a first positioning pattern or based on a first positioning pattern and a second positioning pattern, a second electrode pattern to be printed next with a first electrode pattern on which the second electrode pattern to be printed next is overlaid.

### TECHNICAL FIELD

The present disclosure relates to a method for manufacturing a ceramic sheet stack and a method for manufacturing a multilayer ceramic electronic component.

### BACKGROUND OF INVENTION

A known method for manufacturing a ceramic sheet stack and a known method for manufacturing a multilayer ceramic electronic component are described in, for example, Patent Literature 1.

### CITATION LIST

### Patent Literature

Patent Literature 1: Japanese Unexamined Patent Application Publication No. 2001-85271

### SUMMARY

In an aspect of the present disclosure, a method for manufacturing a ceramic sheet stack includes forming a first ceramic sheet, printing a plurality of first electrode patterns and a plurality of first positioning patterns, drying the plurality of first electrode patterns, forming a second ceramic sheet, drying the second ceramic sheet, and printing a plurality of second electrode patterns and a plurality of second positioning patterns. Forming the first ceramic sheet includes forming the first ceramic sheet by applying ceramic slurry on a first surface of a carrier film being elongated. Printing the plurality of first electrode patterns and the plurality of first positioning patterns includes printing, with a gravure roller engraved with an electrode pattern and a positioning pattern and with a conductive paste, the plurality of first electrode patterns and the plurality of first positioning patterns sequentially on a second surface of the first ceramic sheet opposite the carrier film. Forming the second ceramic sheet includes forming the second ceramic sheet by applying the ceramic slurry on an area of the second surface without the plurality of first electrode patterns and the plurality of first positioning patterns being printed, the plurality of first electrode patterns, and the plurality of first positioning patterns. Printing the plurality of second electrode patterns and the plurality of second positioning patterns includes printing, with the gravure roller and the conductive paste, the plurality of second electrode patterns and the plurality of second positioning patterns sequentially on a third surface of the second ceramic sheet opposite the carrier film. Printing the plurality of second electrode patterns and the plurality of second positioning patterns includes aligning, based on at least one of the plurality of first positioning patterns or based on at least one of the plurality of first positioning patterns and at least one of the plurality of second positioning patterns, a second electrode pattern of the plurality of second electrode patterns to be printed next with a first electrode pattern of the plurality of first electrode patterns on which the second electrode pattern to be printed next is overlaid.

In an aspect of the present disclosure, a method for manufacturing a multilayer ceramic electronic component includes cutting a ceramic sheet stack manufactured with the above method into a plurality of ceramic sheet stack pieces, stacking the plurality of ceramic sheet stack pieces on one another to fabricate a multilayer base, cutting the multilayer base to fabricate a base component, firing the base component, and forming an external electrode on the fired base component.

### BRIEF DESCRIPTION OF THE DRAWINGS

The objects, features, and advantages of the present disclosure will be more apparent from the following detailed description and the drawings.

FIG. 1 is a plan view of a ceramic sheet stack manufactured with a method for manufacturing a ceramic sheet stack according to an embodiment of the present disclosure.

FIG. 2 is a cross-sectional view taken along line II-II in FIG. 1.

FIG. 3 is a plan view of first electrode patterns and first positioning patterns printed on a first ceramic sheet.

FIG. 4 is an enlarged plan view of area IV in FIG. 3.

FIG. 5 is a plan view of one of the first electrode patterns after first drying, illustrating its shape.

FIG. 6 is a plan view of the first electrode pattern, describing control of its shape in second printing.

FIG. 7 is a perspective view of a gravure printing apparatus used in first printing and the second printing, illustrating its structure.

FIG. 8 is a plan view of the ceramic sheet stack, describing example alignment in the second printing.

FIG. 9 is a perspective view of a temporary stack, illustrating its fabrication process.

FIG. 10 is a perspective view of a multilayer base.

FIG. 11 is a perspective view of multiple base components cut from the multilayer base.

FIG. 12 is a perspective view of a multilayer ceramic electronic component.

### DESCRIPTION OF EMBODIMENTS

A multilayer ceramic capacitor as an example of a multilayer ceramic electronic component includes a stack including multiple dielectric layers and multiple internal electrode layers stacked alternately on one another. The multilayer ceramic capacitor can be manufactured efficiently by preliminarily fabricating ceramic sheet stacks each including ceramic sheets and electrode patterns alternately stacked on one another, and stacking the ceramic sheet stacks.

Patent Literature 1 describes a method for manufacturing a ceramic sheet stack in which forming a ceramic sheet on a film surface of a carrier film and printing an electrode pattern on a sheet surface of the ceramic sheet are repeated. With the method described in Patent Literature 1, the electrode pattern on the first layer is formed by gravure printing, and electrode patterns on the second and subsequent layers are formed by screen printing.

With the printing speed of screen printing (e.g., less than or equal to 10 m/minute) being slower than the printing speed of gravure printing (e.g., about 50 to 200 m/minute), the known method for manufacturing a ceramic sheet stack cannot easily increase the manufacturing efficiency of ceramic sheet stacks. Additionally, using different printing methods in printing the electrode pattern on the first layer and in printing the electrode patterns on the second and subsequent layers, the known method for manufacturing a ceramic sheet stack is more likely to cause misalignment between electrode patterns, and may thus lower the reliability of the resultant multilayer ceramic capacitor.

A method for manufacturing a ceramic sheet stack and a method for manufacturing a multilayer ceramic electronic component according to one or more embodiments of the present disclosure will be described below with reference to the drawings. The drawings referred to below are schematic and are not necessarily drawn to scale relative to, for example, the actual dimensional ratios. Some of the drawings use an orthogonal xyz coordinate system defined for convenience.

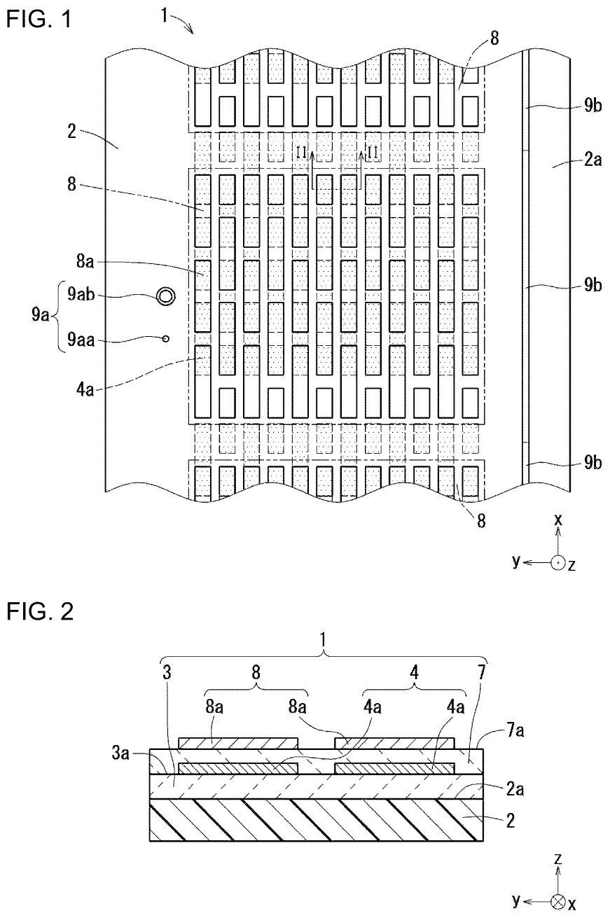

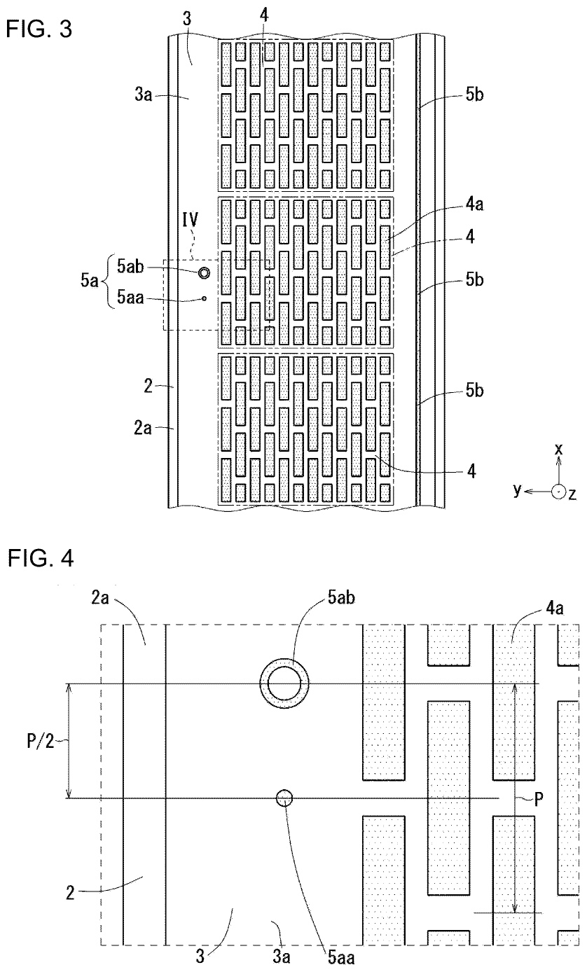

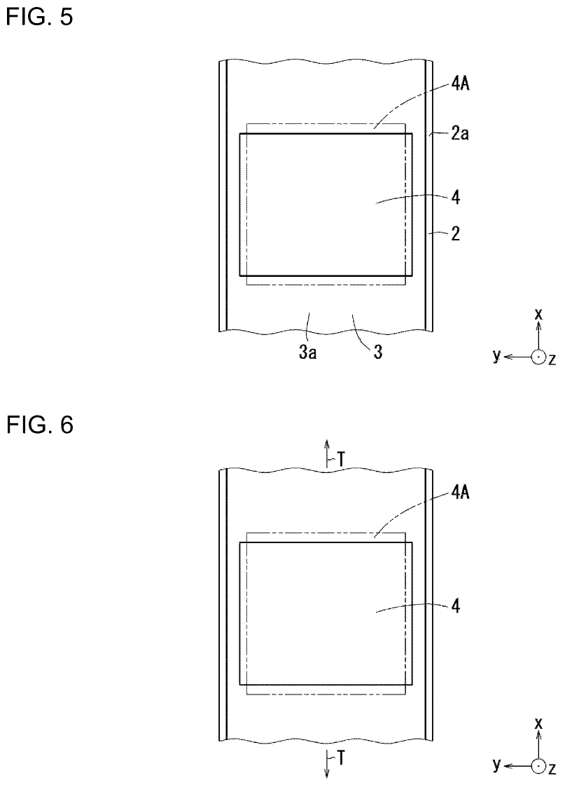

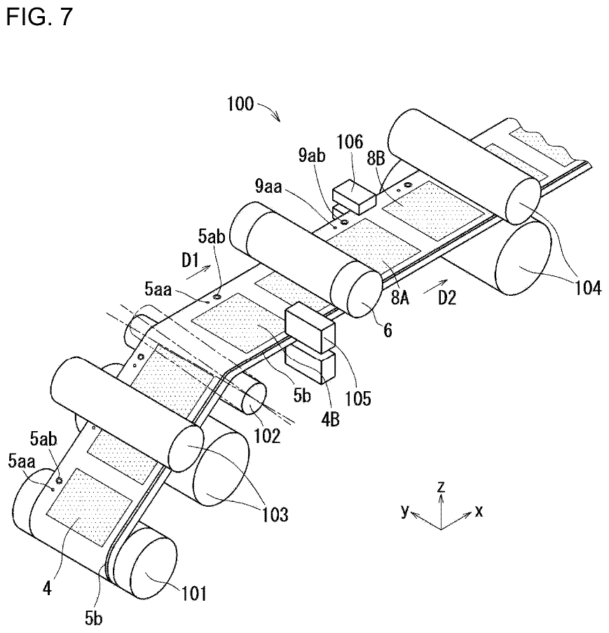

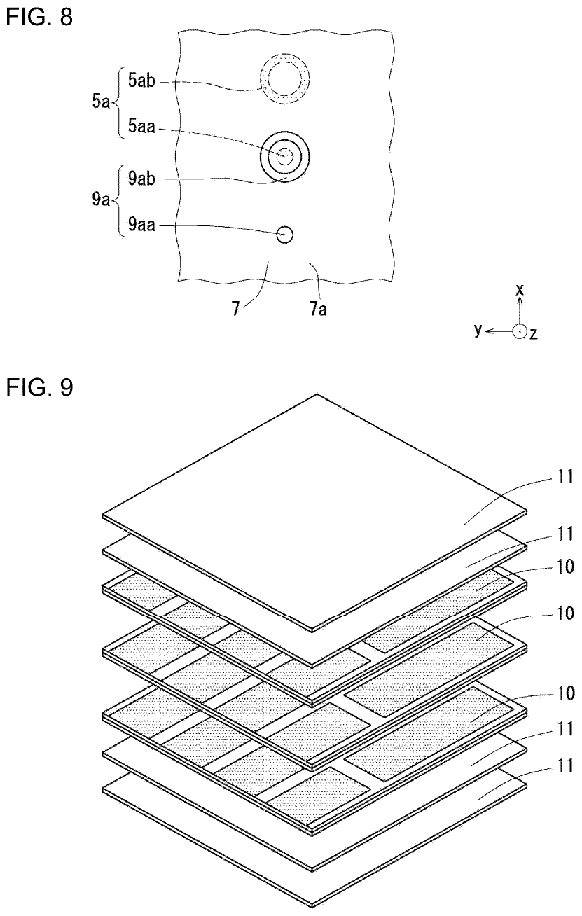

FIG. 1 is a plan view of a ceramic sheet stack manufactured with a method for manufacturing a ceramic sheet stack according to an embodiment of the present disclosure. FIG. 2 is a cross-sectional view taken along line II-II in FIG. 1. FIG. 3 is a plan view of first electrode patterns and first positioning patterns printed on a first ceramic sheet. FIG. 4 is an enlarged plan view of area IV in FIG. 3. FIG. 5 is a plan view of one of the first electrode patterns after first drying, illustrating its shape. FIG. 6 is a plan view of the first electrode pattern, describing control of its shape in second printing. FIG. 7 is a perspective view of a gravure printing apparatus used in first printing and the second printing, illustrating its structure. Note that, in FIG. 1, the first ceramic sheet, a second ceramic sheet, and the first positioning patterns are not illustrated, and island electrodes on the first electrode patterns are hatched. In FIG. 5, the second ceramic sheet is not illustrated, and the first electrode pattern before the first drying and the first electrode pattern after the first drying are schematically illustrated. In FIG. 6, the second ceramic sheet is not illustrated, and the first electrode pattern after the first drying and the first electrode pattern to be deformed by controlling a tension applied to a film are schematically illustrated. FIG. 7 illustrates the gravure printing apparatus performing the second printing. In FIG. 7, the first ceramic sheet and the second ceramic sheet are not illustrated, and the first electrode pattern and the second electrode pattern are hatched and schematically illustrated. In FIG. 8, a first alignment mark and a second alignment mark in the first positioning pattern are hatched.

The method for manufacturing a ceramic sheet stack according to one or more embodiments of the present disclosure includes first forming, first printing, first drying, second forming, second drying, and second printing. As illustrated in FIGS. 1 and 2, a ceramic sheet stack 1 manufactured with the manufacturing method according to one or more embodiments of the present disclosure includes a first ceramic sheet 3, multiple first electrode patterns 4, a second ceramic sheet 7, and multiple second electrode patterns 8. As illustrated in FIGS. 1 and 3, the ceramic sheet stack 1 also includes multiple first positioning patterns 5 and multiple second positioning patterns 9. The multiple first positioning patterns 5 and the multiple second positioning patterns 9 are used to align the multiple first electrode patterns 4 with the multiple second electrode patterns 8. The ceramic sheet stack 1 is manufactured on a carrier film (hereafter also simply referred to as a film) 2.

### First Forming

As illustrated in FIG. 2, the first forming is a process of forming the first ceramic sheet 3 by applying ceramic slurry on a first surface 2a of the film 2.

First, a mixed powder of a dielectric ceramic powder, a rare earth element, and a glass powder is wet-grounded and mixed with a bead mill. The mixed powder is further mixed with an organic vehicle to prepare ceramic slurry. The dielectric ceramic powder may be, for example, a powder of a ceramic material such as barium titanate (BaTiO₃), calcium titanate (CaTiO₃), strontium titanate (SrTiO₃), or zirconate barium (BaZrO₃). The rare earth element may be, for example, yttrium (Y), dysprosium (Dy), holmium (Ho), terbium (Tb), or ytterbium (Yb). The glass powder may be, for example, a SiO₂—BaO—CaO glass powder. The organic vehicle may be, for example, a resin such as a butyral resin dissolved in a solvent being a mixture of ethyl alcohol and toluene.

As illustrated in FIG. 1, the film 2 is elongated, extending in a longitudinal direction and in a lateral direction. The longitudinal direction and the lateral direction of the film 2 are also respectively referred to as a first direction (x-direction) and a second direction (y-direction). The film 2 may have any dimensions, but may have a length of, for example, about 1000 to 20000 m in the longitudinal direction, a length of, for example, about 200 to 500 mm in the lateral direction, and a thickness of, for example, about 5 to 100 μm. The film 2 may be made of a resin material such as polyethylene terephthalate (PET), polyethylene naphthalate (PEN), or polypropylene (PP).

The prepared ceramic slurry is then applied on the first surface 2a of the film 2 to form the first ceramic sheet 3. The first ceramic sheet 3 serves as a dielectric layer in a multilayer ceramic electronic component. The first ceramic sheet 3 may be formed with a known forming method such as die coating or doctor blading. The first ceramic sheet 3 may have a thickness of, for example, about 0.5 to 2.0 μm.

### First Printing

The first printing is a process of sequentially printing, by gravure printing, the multiple first electrode patterns 4 and the multiple first positioning patterns 5 on a second surface 3a of the first ceramic sheet 3. The second surface 3a is a surface of the first ceramic sheet 3 opposite the carrier film 2. The multiple first electrode patterns 4 and the multiple first positioning patterns 5 are formed with a conductive paste.

A gravure roller (also referred to as a gravure cylinder) 6 for gravure printing and the conductive paste are prepared first. The gravure roller 6 is a cylinder (refer to FIG. 7) with its outer circumferential surface engraved with print patterns corresponding to graphic patterns to be printed (in other words, the first electrode patterns 4 and the first positioning patterns 5). The conductive paste is prepared by mixing a metal powder with an organic vehicle. The metal powder may be, for example, a powder of a metal material such as nickel (Ni), palladium (Pd), copper (Cu), or silver (Ag). The metal powder may contain Ni as a main component. The organic vehicle mixed with the metal powder may be, for example, a resin such as ethyl cellulose dissolved in a solvent containing a mixture of a dihydroterpineol solvent and butyl cellosolve.

The multiple first electrode patterns 4 and the multiple first positioning patterns 5 may be gravure printed with a gravure printing apparatus 100 (described later). The printing speed of gravure printing may be, for example, about 50 to 200 m/minute.

The first electrode patterns 4 serve as internal electrode layers in the multilayer ceramic electronic component. In the present embodiment, as illustrated in FIG. 3, each of the first electrode patterns 4 includes multiple island electrodes 4a in a staggered arrangement. The dimensions of each of the island electrodes 4a may be set as appropriate for the specifications of the multilayer ceramic electronic component. The arrangement of the multiple island electrodes 4a is not limited to a staggered arrangement. For example, the island electrodes 4a each elongated in the second direction (y-direction) may be arranged in the first direction (x-direction). As illustrated in FIG. 3, the first electrode patterns 4 may be printed on a middle portion of the first ceramic sheet 3 in the second direction (y-direction) in a plan view.

The first positioning patterns 5 are used to align the first electrode patterns 4 with the second electrode patterns (described later). In the present embodiment, as illustrated in FIG. 3, each of the first positioning patterns 5 includes an alignment mark 5a and a positioning line 5b.

As illustrated in FIG. 4, the alignment mark 5a may include a circular first alignment mark 5aa and an annular second alignment mark 5ab. With the pitch between the multiple island electrodes 4a in the first direction being P, the centroid of the first alignment mark 5aa and the centroid of the second alignment mark 5ab may be spaced from each other by P/2 times a natural number in the first direction. The centroid of the first alignment mark 5aa and the centroid of the second alignment mark 5ab may be spaced from each other by P/2 in the first direction.

Multiple positioning lines 5b are lines or strips extending in the first direction. As illustrated in FIG. 3, one positioning line 5b may connect to positioning lines 5b adjacent to the positioning line 5b. In other words, the multiple positioning lines 5b may extend continuously in the first direction.

As illustrated in FIG. 3, the alignment mark 5a may be printed near one end of the second surface 3a in the second direction (y-direction), and the positioning line 5b may be printed near the other end of the second surface 3a in the second direction (y-direction).

### First Drying

The first drying is a process of drying the multiple first electrode patterns 4. The first electrode patterns 4 may be dried with a drying furnace (not illustrated).

The film 2 holding the first ceramic sheet 3 on which the first electrode patterns 4 are printed is loaded into the drying furnace. The first electrode patterns 4 are heated to a first temperature and dried. The film 2 is thus heated to the first temperature as well in the first drying. The first temperature may be higher than or equal to the softening point of the film 2. In this case, when unloaded from the drying furnace and cooled, the film 2 deforms to shrink in the first direction (x-direction) and expand in the second direction (y-direction). As the film 2 deforms, the first electrode patterns 4 deform to shrink in the first direction and expand in the second direction. Thus, as illustrated in FIG. 5, each of the first electrode patterns 4 deforms from the shape of a first electrode pattern 4A before the first drying (in other words, the shape corresponding to the print pattern engraved on the gravure roller 6). In the second printing, however, a tension T in the first direction is applied to the film 2 as illustrated in FIG. 6 to deform the film 2 and each of the first electrode patterns 4 to expand in the first direction and shrink in the second direction (in other words, to cause the shape of the first electrode pattern 4 to be closer to the shape of the first electrode pattern 4A). In this manner, the first electrode patterns 4 can be aligned with the second electrode patterns 8.

Note that when the film 2 after the first forming (in other words, the film 2 holding the first ceramic sheet 3) undergoes the first printing and the first drying, the film 2 may then be delivered to the subsequent second forming without being wound around a roller again or being unwound from a roller. This allows efficient manufacture of the ceramic sheet stack 1.

### Second Forming

The second forming is a process of forming the second ceramic sheet 7 as illustrated in FIG. 2 by applying ceramic slurry on areas of the second surface 3a of the first ceramic sheet 3 without the multiple first electrode patterns 4 and the multiple first positioning patterns 5 being printed, on the multiple first electrode patterns 4, and on the multiple first positioning patterns 5. The ceramic slurry may be the ceramic slurry used in forming the first ceramic sheet 3. The second ceramic sheet 7 may be formed with the same forming method as the first ceramic sheet 3. The second ceramic sheet 7 may be as thick as the first ceramic sheet 3.

### Second Drying

The second drying is a process of drying the second ceramic sheet 7. In the second drying, in the same manner as or in a similar manner to the first drying, the film 2 holding the first ceramic sheet 3 on which the first electrode patterns 4 are printed and the second ceramic sheet 7 is loaded into the drying furnace. The second ceramic sheet 7 is heated to a second temperature and dried. The film 2 is thus heated to the second temperature as well in the second drying. The second temperature may be lower than the softening point of the film 2. This can reduce deformation of the film 2 holing the first ceramic sheet 3 on which the first electrode patterns 4 are printed and the second ceramic sheet 7, and thus can reduce unintended deformation of the first electrode patterns 4 (e.g., the first electrode patterns 4 deforming to expand in the first direction). Thus, in the second printing, the tension T in the first direction applied to the film 2 allows alignment between the first electrode patterns 4 and the second electrode patterns 8.

Note that, when the film 2 after the first drying (in other words, the film 2 holding the first ceramic sheet on which the first electrode patterns 4 are printed) undergoes the second forming and the second drying, the film 2 may then be delivered to the subsequent second printing without being wound around a roller again or being unwound from a roller. In this case, the film 2 in the second printing can be fed in the same feed direction as the film 2 in the first printing. Thus, in the second printing, the second electrode patterns can be printed more easily at positions aligning, in the lateral direction of the film 2, with positions at which the first electrode patterns 4 have been printed.

### Second Printing

As illustrated in FIGS. 1 and 2, the second printing is a process of sequentially printing, by gravure printing, the multiple second electrode patterns 8 and the multiple second positioning patterns 9 on a third surface 7a of the second ceramic sheet 7. The third surface 7a is a surface of the second ceramic sheet 7 opposite the carrier film 2. The multiple second electrode patterns 8 and the multiple second positioning patterns 9 are printed with the gravure roller 6 used in the first printing. The multiple second electrode patterns 8 and the multiple second positioning patterns 9 are formed with the conductive paste used in the first printing.

In the second printing, the multiple second electrode patterns 8 and the multiple second positioning patterns 9 are printed with the gravure roller 6 used in the first printing. Thus, the second electrode patterns 8 are the same patterns as the first electrode patterns 4 and include multiple island electrodes 8a in a staggered arrangement. Each of the second positioning patterns 9 includes an alignment mark 9a and a positioning line 9b in the same manner as or in a similar manner to the first positioning pattern 5. As illustrated in FIG. 1, the alignment mark 9a includes a circular first alignment mark 9aa and an annular second alignment mark 9ab.

In sequentially printing the multiple second electrode patterns 8 and the multiple second positioning patterns 9 in the second printing, alignment of a second electrode pattern 8 to be printed next with the first electrode pattern 4 on which the second electrode pattern 8 to be printed next is overlaid (hereafter also simply referred to as alignment) is performed. In the second printing, alignment is performed based on at least one first positioning pattern 5 or based on at least one first positioning pattern 5 and at least one second positioning pattern 9.

The method for manufacturing a ceramic sheet stack according to the present embodiment can efficiently manufacture the ceramic sheet stack 1, with both the first electrode patterns 4 and the second electrode patterns 8 printed by gravure printing having a relatively higher printing speed (a higher printing speed than the screen printing).

With the method for manufacturing a ceramic sheet stack according to the present embodiment, the gravure roller 6 used in printing the first electrode patterns 4 is also used to print the second electrode patterns 8. This can reduce misalignment of the first electrode patterns 4 and the second electrode patterns 8 resulting from, for example, manufacturing tolerances of the gravure roller 6, allowing efficient manufacture of the multilayer ceramic electronic component with higher reliability.

With the method for manufacturing a ceramic sheet stack according to the present embodiment, the second electrode patterns 8 are printed while being aligned. This can further reduce misalignment between the first electrode patterns 4 and the second electrode patterns 8, allowing efficient manufacture of the multilayer ceramic electronic component with still higher reliability.

The gravure printing apparatus (hereafter also simply referred to as a printing apparatus) 100 used in the first printing and the second printing is now described with reference to FIG. 7. Although the operation of the printing apparatus 100 in the second printing are described below, the printing apparatus 100 operates in the same or a similar manner in the first printing except that the first printing is performed on a different print target and involves no alignment.

The printing apparatus 100 includes a feed roller 101, a guide roller 102, the gravure roller 6, first nip rollers 103, second nip rollers 104, a line sensor 105, and a camera 106. The printing apparatus 100 may include components that are not illustrated, such a guide roller, a take-up roller, a driver, and a controller. The driver drives each of the rollers in the printing apparatus 100. The controller controls each of the rollers in the printing apparatus 100 and the driver.

The film 2 holding the first ceramic sheet 3 on which the first electrode patterns 4 and the first positioning patterns 5 are printed and the second ceramic sheet 7 is wound around the feed roller 101. The first ceramic sheet 3 on which the first electrode patterns 4 and the first positioning patterns 5 are printed and the second ceramic sheet 7 are hereafter also collectively referred to as a first precursor. The film 2 holding the first precursor is unwound from the feed roller 101 during the second printing.

The guide roller 102 is located between the feed roller 101 and the gravure roller 6 in a feed direction D1 of the film 2 holding the first precursor. The center line (rotational axis) of the guide roller 102 is displaceable. The center line of the guide roller 102 can be displaced to adjust the position of the film 2 holding the first precursor in the second direction.

The line sensor 105 is configured to detect the position of the positioning line 5b of the first positioning pattern 5. The line sensor 105 is located between the guide roller 102 and the gravure roller 6 in the feed direction D1.

The camera 106 is configured to detect the alignment mark 5a in the first positioning pattern 5 and the alignment mark 9a in the second positioning pattern 9. The camera 106 is located downstream from the gravure roller 6 in a feed direction D2 of the film 2 holding the first precursor on which the second electrode patterns 8 and the second positioning patterns 9 are printed. The first precursor on which the second electrode patterns 8 and the second positioning patterns 9 are printed is hereafter also referred to as a second precursor.

The first nip rollers 103 are located between the feed roller 101 and the gravure roller 6 in the feed direction D1. Although the first nip rollers 103 are located upstream from the guide roller 102 and the line sensor 105 in the feed direction D1 in FIG. 7, the first nip rollers 103 may be positioned as appropriate with respect to the guide roller 102 and the line sensor 105. The second nip rollers 104 are located downstream from the gravure roller 6 in the feed direction D2. Although the second nip rollers 104 are located downstream from the camera 106 in the feed direction D2 in FIG. 7, the second nip rollers 104 may be positioned as appropriate with respect to the camera 106. At least one of the first nip rollers 103 or the second nip rollers 104 may be replaced with a suction roller.

The printing apparatus 100 may include the take-up roller (not illustrated) downstream from the camera 106 and the second nip rollers 104 in the feed direction D2. The take-up roller winds and collects the film 2 holding the second precursor. The take-up roller may wind the film 2 holding the second precursor before or after the second drying.

Alignment in the second printing is described. Alignment based on at least one first positioning pattern 5 is now described. The first positioning pattern 5 used for alignment (hereafter also referred to as a first reference pattern) may be the positioning line 5b located laterally in the second direction from the first electrode pattern 4B (refer to FIG. 7) on which the second electrode pattern 8 to be printed next is overlaid.

In alignment, the line sensor 105 detects the first reference pattern to align the position of the first reference pattern in the second direction with the position of the positioning line 9b to be printed by the printing apparatus 100. In this manner, the second electrode pattern 8 to be printed next can be aligned in the second direction with the first electrode pattern 4 on which the second electrode pattern 8 to be printed next is overlaid. Alignment can be performed by adjusting the position of the film 2 holding the first precursor in the second direction. The position of the film 2 holding the first precursor can be adjusted in the second direction by changing the orientation of the center line (rotation axis) of the guide roller 102. In this manner, the second electrode pattern 8 to be printed next can be aligned in the second direction with the first electrode pattern 4 on which the second electrode pattern 8 to be printed next is overlaid.

In the alignment based on the first positioning pattern 5, the first reference pattern may be the positioning line 5b located laterally in the second direction from the first electrode pattern 4 on which a second electrode pattern 8 to be printed after the next second electrode pattern 8 is overlaid. The first reference pattern may instead be the positioning line 5b located laterally in the second direction from the first electrode pattern 4 on which the second electrode pattern 8 to be printed next is overlaid, and the positioning line 5b located laterally in the second direction from the first electrode pattern 4 on which the second electrode pattern 8 to be printed after the next second electrode pattern 8 is overlaid. This can accurately align the first electrode patterns 4 with the second electrode patterns 8 in the second direction.

Alignment based on at least one first positioning pattern 5 and at least one second positioning pattern 9 is now described. The first positioning pattern 5 and the second positioning pattern 9 (hereafter also referred to as a second reference pattern) for alignment may include the alignment mark 9a located laterally in the second direction from a second electrode pattern 8A (refer to FIG. 7) that has been printed and the alignment mark 5a located laterally in the second direction from the first electrode pattern 4 on which the second electrode pattern 8A is overlaid.

In alignment, the camera 106 detects the second reference pattern to measure the distance between the centroid of the second alignment mark 9ab in the alignment mark 9a and the centroid of the first alignment mark 5aa in the alignment mark 5a. Subsequently, the tension T is applied to the film 2 holding the first precursor based on the measured distance to align the centroid of the second alignment mark 9ab located laterally in the second direction from the second electrode pattern 8 to be printed next with the centroid of the first alignment mark 5aa located laterally in the second direction from the first electrode pattern 4 on which the second electrode pattern 8 to be printed next is overlaid (refer to FIG. 8). This can align the second electrode pattern 8 to be printed next in the first direction with the first electrode pattern 4 on which the second electrode pattern 8 to be printed next is overlaid, allowing the second electrode pattern 8 to be overlaid on the corresponding first electrode pattern 4 while being displaced in the first direction by a predetermined distance (P/2) for manufacturing the multilayer ceramic electronic component. Alignment can be performed by adjusting the feed speeds of the first nip rollers 103 and the second nip rollers 104. Alignment can be performed by adjusting the feed speed of the second nip rollers 104 to be faster than the feed speed of the first nip rollers 103 to apply the tension T in the first direction to the film 2 holding the first precursor.

With the method for manufacturing a ceramic sheet stack according to the present embodiment, the first drying deforms the film 2 holding the first precursor and the first precursor to shrink in the first direction and expand in the second direction compared with the shape of the first electrode pattern 4A before the first drying (in other words, the shape corresponding to the print pattern engraved on the gravure roller 6). The tension T in the first direction thus allows alignment with a wider adjustable range. The second electrode pattern 8 can thus be accurately overlaid on the first electrode pattern 4 in the first direction. Additionally, with the tension T in the first direction applied to the film 2 holding the first precursor, the dimension of the first precursor in the second direction can be changed (can be smaller). Thus, the second electrode pattern 8 to be printed next can be aligned in the second direction with the first electrode pattern 4 on which the second electrode pattern 8 to be printed next is overlaid. Note that, in the alignment based on the first positioning pattern 5 and the second positioning pattern 9, the first reference pattern may be further used for alignment in the second direction as described above. In this case, the second electrode pattern 8 to be printed next can be aligned in the first direction and in the second direction with the first electrode pattern 4 on which the second electrode pattern 8 to be printed is overlaid.

In the alignment based on the first positioning pattern 5 and the second positioning pattern 9, the second reference pattern may be the alignment mark 9a located laterally in the second direction from the second electrode pattern 8A, the alignment mark 9a located laterally in the second direction from a second electrode pattern 8B (refer to FIG. 7) that has been printed immediately before the second electrode pattern 8A, the alignment mark 5a located laterally in the second direction from the first electrode pattern 4 on which the second electrode pattern 8A is overlaid, and the alignment mark 5a located laterally in the second direction from the first electrode pattern 4 on which the second electrode pattern 8B is overlaid. In this case, the second electrode pattern 8 to be printed next can be accurately aligned in the first direction and in the second direction with the first electrode pattern 4 on which the second electrode pattern 8 to be printed next is overlaid.

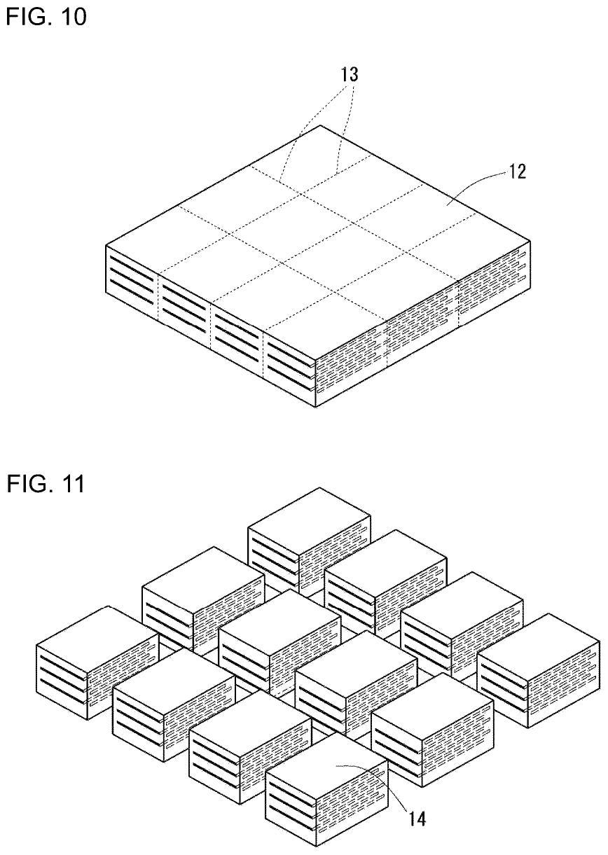

Each of the first positioning pattern 5 and the second positioning pattern 9 may include a stacking alignment mark (not illustrated) in addition to the alignment mark 5a or 9a and the positioning line 5b or 9b. Stacking alignment marks can be used to align multiple ceramic sheet stack pieces 10 in a stacking direction to fabricate a temporary stack (refer to FIG. 9).

The second printing may be followed by a third drying to dry the multiple second electrode patterns 8. Although the ceramic sheet stack 1 manufactured with the method described above includes two layers of ceramic sheets (the first ceramic sheet 3 and the second ceramic sheet 7) and two layers of electrode patterns (the first electrode pattern 4 and the second electrode pattern 8), the second forming, the second drying, and the second printing may be repeated to manufacture a ceramic sheet stack including three or more layers of ceramic sheets and three or more layers of electrode patterns.

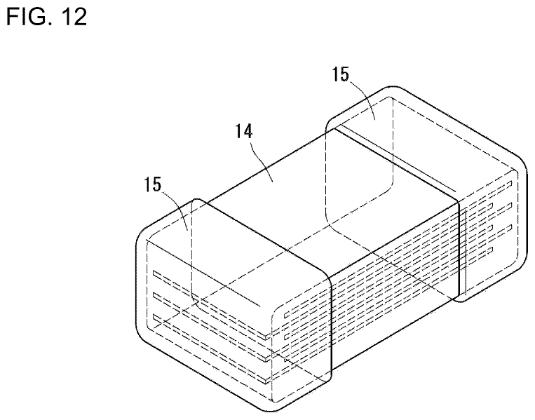

A method for manufacturing a multilayer ceramic electronic component is now described. FIG. 9 is a perspective view of the temporary stack, illustrating its fabrication process. FIG. 10 is a perspective view of a multilayer base. FIG. 11 is a perspective view of multiple base components cut from the multilayer base. FIG. 12 is a perspective view of the multilayer ceramic electronic component.

The ceramic sheet stack 1 is cut into multiple ceramic sheet stack pieces 10 in the lateral direction (y-direction) of the carrier film 2. Each of the ceramic sheet stack pieces 10 may include the entire portion of one first electrode pattern 4 and the entire portion of one second electrode pattern 8.

As illustrated in FIG. 9, the multiple ceramic sheet stack pieces 10 are then stacked on one another to fabricate the temporary stack. Two ends of the temporary stack in the stacking direction may receive one or more layers of ceramic sheets 11 without electrode patterns. Subsequently, a pressure is applied to the temporary stack in its staking direction to fabricate a multilayer base 12 as illustrated in FIG. 10. The temporary stack may receive a pressure from, for example, a hydrostatic press device. In fabricating the temporary stack, the multiple ceramic sheet stack pieces 10 may be aligned in the stacking direction based on the stacking alignment marks included in the first positioning patterns 5 and the second positioning patterns 9. In this case, the multiple ceramic sheet stack pieces 10 can be stacked accurately, allowing manufacture of the multilayer ceramic electronic component with higher reliability.

The multilayer base 12 is then cut along imaginary separation lines 13 to fabricate multiple unfired base components 14. The multilayer base 12 may be cut with, for example, a press-cutter, a dicing saw, or a laser cutter. As illustrated in FIG. 11, Each of the base components 14 includes a first end face and a second end face opposite each other. The first electrode patterns 4 are partially exposed in the first end face, and the second electrode patterns 8 are partially exposed in the second end face.

The unfired base components 14 are degreased at an atmospheric pressure or at a reduced pressure in an ambient atmosphere, an inert gas atmosphere, or a reducing atmosphere before being fired in a reducing atmosphere. The firing temperature may be, for example, about 1100 to 1300 °C. The fired base components 14 are then reoxidized in a nitrogen atmosphere. The reoxidized base components 14 are placed in a pot containing an abrasive powder or an abrasive medium. The pot is rotated for polishing to round corners and deburr the base components 14. External electrodes 15 are then formed on each of the rounded and deburred base components 14 to manufacture a multilayer ceramic electronic component 16 as illustrated in FIG. 12. The external electrodes 15 may be formed by, for example, coating surfaces of the base component 14 including the first end face and the second end face with underlayers including a metal material such as copper (Cu), baking the coated base component 14, and plating the underlayers with nickel (Ni) and tin (Sn) in this order.

The method for manufacturing a multilayer ceramic electronic component according to one or more embodiments of the present disclosure uses the ceramic sheet stack 1 to manufacture a multilayer ceramic electronic component. The method can thus manufacture the multilayer ceramic electronic component with higher reliability.

### Working Example

The method for manufacturing a ceramic sheet stack described above was used to fabricate ceramic sheet stacks 1 (samples No. 1 to 3 in Table 1) as working examples. The carrier film 2 was a PET film with a width of 400 mm and a thickness of 31 μm. On an 8000-meter long area of the carrier film 2, 20000 first electrode patterns 4, 20000 first positioning patterns 5, 20000 second electrode patterns 8, and 20000 second positioning patterns 9 were gravure printed. The printing speed of gravure printing was set to 100 m/minute. The printing method in Table 1 indicates the printing method for the second electrode patterns 8. The first temperature was set to 80 to 90 °C that is higher than or equal to the softening point of PET (74 °C). The second temperature was set to 70 °C that is lower than the softening point of PET. The first electrode patterns 4 and the second electrode patterns 8 were aligned in the first direction and in the second direction based on the first positioning patterns 5 and the second positioning patterns 9.

For each pair of the first positioning pattern 5 and the second positioning pattern 9, the displacement of the centroid of the first alignment mark 5aa in the first positioning pattern 5 from the centroid of the second alignment mark 9ab in the second positioning pattern 9 is measured to calculate 3σ (three times the standard deviation) of the distribution of displacements in the first direction and 3σ of the distribution of the displacements in the second direction. The results are shown in the width variation and the length variation in Table 1. The width variation indicates 3σ of the displacements in the second direction, and the length variation indicates 3σ of the displacements in the first direction.

The method for manufacturing a multilayer ceramic electronic component described above was also used to fabricate 300 multilayer ceramic electronic components 16 from the ceramic sheet stack 1. Each of the multilayer ceramic electronic components 16 is a 1005-size multilayer ceramic capacitor with a length of 1.0 mm, a width of 0.5 mm, and a height of 0.5 mm. A high temperature humidity resistance test was conducted on the 300 multilayer ceramic electronic components 16 to measure the number of multilayer ceramic capacitors determined defective among the 300 multilayer ceramic capacitors in the test. A multilayer ceramic capacitor was determined defective in the high temperature humidity resistance test when having an insulation resistance less than or equal to 1 MΩ after receiving a voltage of 6.3 V across its external electrodes for 48 hours in an environment with the temperature of 85 °C and the humidity of 85%. The results are shown in the temperature humidity test in Table 1.

Samples No. 4 to 6 in Table 1 were fabricated as comparative examples. In the same manner as or a similar manner to the working examples, the width variation and the length variation were calculated for each sample, and the high temperature humidity resistance test was conducted to measure the number of multilayer ceramic capacitors determined defective. The sample No. 4 is the same as or similar to the samples No. 1 to 3 except that both the first temperature and the second temperature were lower than the softening point of the film 2. For the sample No. 5, both the first temperature and the second temperature were higher than the softening point of the film 2. Compared with the shape of the first electrode pattern 4A before the first drying (more specifically, the shape corresponding to the print pattern engraved on the gravure roller 6), the ceramic sheet stack being the sample No. 5 and the film holding the ceramic sheet stack expanded in the first direction after the second drying. Thus, the sample No. 5 failed to undergo alignment using a tension in the second printing. The sample No. 6 is the same as or similar to the sample No. 2 except that the second electrode patterns were screen printed. The speed of screen printing was set to 7.5 m/minute.

TABLE 1

| | | | | | | High |
|---|---|---|---|---|---|---|
| | | | | | | temperature |
| | Printing | First | Second | Width | Length | humidity |
| Sample No. | method | temperature | temperature | variation | variation | resistance test |
| 1 | Gravure | 80 °C | 70 °C | 7.0 μm | 11.2 μm | 0/300 |
| 2 | Gravure | 90 °C | 70 °C | 5.1 μm | 9.0 μm | 0/300 |
| 3 | Gravure | 100 °C | 70 °C | 9.8 μm | 11.8 μm | 0/300 |
| 4 | Gravure | 70 °C | 70 °C | 25.0 μm | 15.3 μm | 1/300 |
| 5 | Gravure | 80 °C | 90 °C | | | |
| 6 | Screen | 90 °C | 70 °C | 35.8 μm | 15.0 μm | 9/300 |

In each of the samples No. 1 to 3 having the width variation less than or equal to 10 μm and the length variation less than or equal to 15 μm, the first positioning patterns 5 are accurately aligned with the second positioning patterns 9. In other words, each of the samples No. 1 to 3 includes the first electrode patterns 4 and the second electrode patterns 8 that are accurately overlaid on each other in the second direction while being displaced in the first direction by the predetermined distance (P/2). No multilayer ceramic electronic components were determined defective in the high temperature humidity resistance test.

The sample No. 4 had a greater width variation and a greater length variation than the samples No. 1 to 3, with one multilayer ceramic electronic component determined defective in the high temperature humidity resistance test. In the sample No. 4 for which the first temperature was lower than the softening point of the PET film, the first electrode patterns did not deform in the manner as illustrated in FIG. 5. This suggests that the adjustable range for alignment with the tension T in the first direction was reduced in the second printing, increasing the width variation and the length variation. This also suggests that, with the greater width variation and the greater length variation in the sample No. 4, the likelihood of defects was increased in forming the internal electrode layers in the multilayer ceramic capacitors.

The sample No. 6 had a greater width variation and a greater length variation than the samples No. 1 to 3, with nine multilayer ceramic electronic components determined defective in the high temperature humidity resistance test. In the sample No. 6 that underwent screen printing in the second printing, alignment by controlling the tension applied to the film was not performed for the first electrode patterns and the second electrode patterns. This suggests an increase in the width variation and the length variation. This also suggests that, with the greater width variation and the greater length variation in the sample No. 6, the likelihood of defects was increased in forming the internal electrode layers in the multilayer ceramic capacitors.

The method for manufacturing a ceramic sheet stack according to one or more embodiments of the present disclosure allows efficient manufacture of the ceramic sheet stack with less misalignment between the first electrode patterns and the second electrode patterns. The method for manufacturing a multilayer ceramic electronic component according to one or more embodiments of the present disclosure uses the ceramic sheet stack manufactured with the method for manufacturing a ceramic sheet stack described above to manufacture multilayer ceramic electronic components, allowing efficient manufacture of multilayer ceramic electronic components with higher reliability.

The present disclosure may have aspects (1) to (8) described below.
(1) A method for manufacturing a ceramic sheet stack, the method comprising:
forming a first ceramic sheet by applying ceramic slurry on a first surface of a carrier film being elongated;
printing, with a gravure roller engraved with an electrode pattern and a positioning pattern and with a conductive paste, a plurality of first electrode patterns and a plurality of first positioning patterns sequentially on a second surface of the first ceramic sheet opposite the carrier film;
drying the plurality of first electrode patterns;
forming a second ceramic sheet by applying the ceramic slurry on an area of the second surface without the plurality of first electrode patterns and the plurality of first positioning patterns being printed, the plurality of first electrode patterns, and the plurality of first positioning patterns;
drying the second ceramic sheet; and
printing, with the gravure roller and the conductive paste, a plurality of second electrode patterns and a plurality of second positioning patterns sequentially on a third surface of the second ceramic sheet opposite the carrier film, printing the plurality of second electrode patterns and the plurality of second positioning patterns including aligning, based on at least one of the plurality of first positioning patterns or based on at least one of the plurality of first positioning patterns and at least one of the plurality of second positioning patterns, a second electrode pattern of the plurality of second electrode patterns to be printed next with a first electrode pattern of the plurality of first electrode patterns on which the second electrode pattern to be printed next is overlaid.

(2) The method according to (1), wherein
each of the plurality of first positioning patterns includes an alignment mark and a positioning line, and each of the plurality of second positioning patterns includes an alignment mark and a positioning line.

(3) The method according to (2), wherein
printing the plurality of second electrode patterns and the plurality of second positioning patterns includes aligning, in a lateral direction of the carrier film, the second electrode pattern to be printed next with the first electrode pattern on which the second electrode pattern to be printed next is overlaid, based on the positioning line of at least one of the plurality of first electrode patterns.

(4) The method according to (2) or (3), wherein
printing the plurality of second electrode patterns and the plurality of second positioning patterns includes aligning, in a longitudinal direction of the carrier film, the second electrode pattern to be printed next with the first electrode pattern on which the second electrode pattern to be printed next is overlaid, based on the alignment mark in at least one of the plurality of first electrode patterns and the alignment mark in at least one of the plurality of second positioning patterns.

(5) The method according to (4), wherein
printing the plurality of second electrode patterns and the plurality of second positioning patterns includes aligning, in the longitudinal direction of the carrier film, the second electrode pattern to be printed next with the first electrode pattern on which the second electrode pattern to be printed next is overlaid by applying a tension to the carrier film in the longitudinal direction.

(6) The method according to any one of (1) to (5), wherein
the carrier film comprises a resin material, and
drying the plurality of first electrode patterns includes drying the plurality of first electrode patterns at a peak temperature higher than or equal to a softening point of the carrier film.

(7) The method according to (6), wherein
drying the second ceramic sheet includes drying the second ceramic sheet at a peak temperature lower than the softening point.

(8) A method for manufacturing a multilayer ceramic electronic component, the method comprising:
cutting a ceramic sheet stack manufactured with the method according to any one of (1) to (7) into a plurality of ceramic sheet stack pieces;
stacking the plurality of ceramic sheet stack pieces on one another to fabricate a multilayer base;
cutting the multilayer base to fabricate a base component;
firing the base component; and
forming an external electrode on the fired base component.

Although embodiments of the present disclosure have been described in detail, the present disclosure is not limited to the embodiments described above, and may be changed or varied in various manners without departing from the spirit and scope of the present disclosure. The present disclosure is not limited to the examples described above.

### REFERENCE SIGNS

1 ceramic sheet stack
2 carrier film
2a first surface
3 first ceramic sheet
3a second surface
4, 4A, 4B first electrode pattern
4a island electrode
5 first positioning pattern
5a alignment mark
5aa first alignment mark
5ab second alignment mark
5b positioning line
6 gravure roller
7 second ceramic sheet
7a third surface
8, 8A, 8B second electrode pattern
8a island electrode
9 second positioning pattern
9a alignment mark
9aa first alignment mark
9ab second alignment mark
9b positioning line
10 ceramic sheet stack piece
11 ceramic sheet
12 multilayer base
13 imaginary separation line
14 base component
15 external electrode
16 multilayer ceramic electronic component
100 gravure printing apparatus
101 feed roller
102 guide roller
103 first nip roller
104 second nip roller
105 line sensor
106 camera

1. A method for manufacturing a ceramic sheet stack, the method comprising:
forming a first ceramic sheet by applying ceramic slurry on a first surface of a carrier film being elongated;
printing, with a gravure roller engraved with an electrode pattern and a positioning pattern and with a conductive paste, a plurality of first electrode patterns and a plurality of first positioning patterns sequentially on a second surface of the first ceramic sheet opposite the carrier film;
drying the plurality of first electrode patterns;
forming a second ceramic sheet by applying the ceramic slurry on an area of the second surface without the plurality of first electrode patterns and the plurality of first positioning patterns being printed, the plurality of first electrode patterns, and the plurality of first positioning patterns;
drying the second ceramic sheet; and
printing, with the gravure roller and the conductive paste, a plurality of second electrode patterns and a plurality of second positioning patterns sequentially on a third surface of the second ceramic sheet opposite the carrier film, printing the plurality of second electrode patterns and the plurality of second positioning patterns including aligning, based on at least one of the plurality of first positioning patterns or based on at least one of the plurality of first positioning patterns and at least one of the plurality of second positioning patterns, a second electrode pattern of the plurality of second electrode patterns to be printed next with a first electrode pattern of the plurality of first electrode patterns on which the second electrode pattern to be printed next is overlaid.

2. The method according to claim 1, wherein
each of the plurality of first positioning patterns includes an alignment mark and a positioning line, and each of the plurality of second positioning patterns includes an alignment mark and a positioning line.

3. The method according to claim 2, wherein
printing the plurality of second electrode patterns and the plurality of second positioning patterns includes aligning, in a lateral direction of the carrier film, the second electrode pattern to be printed next with the first electrode pattern on which the second electrode pattern to be printed next is overlaid, based on the positioning line of at least one of the plurality of first electrode patterns.

4. The method according to claim 2, wherein
printing the plurality of second electrode patterns and the plurality of second positioning patterns includes aligning, in a longitudinal direction of the carrier film, the second electrode pattern to be printed next with the first electrode pattern on which the second electrode pattern to be printed next is overlaid, based on the alignment mark in at least one of the plurality of first electrode patterns and the alignment mark in at least one of the plurality of second positioning patterns.

5. The method according to claim 4, wherein
printing the plurality of second electrode patterns and the plurality of second positioning patterns includes aligning, in the longitudinal direction of the carrier film, the second electrode pattern to be printed next with the first electrode pattern on which the second electrode pattern to be printed next is overlaid by applying a tension to the carrier film in the longitudinal direction.

6. The method according to claim 1, wherein
the carrier film comprises a resin material, and
drying the plurality of first electrode patterns includes drying the plurality of first electrode patterns at a peak temperature higher than or equal to a softening point of the carrier film.

7. The method according to claim 6, wherein
drying the second ceramic sheet includes drying the second ceramic sheet at a peak temperature lower than the softening point.

8. A method for manufacturing a multilayer ceramic electronic component, the method comprising:
cutting a ceramic sheet stack manufactured with the method according to claim 1 into a plurality of ceramic sheet stack pieces;
stacking the plurality of ceramic sheet stack pieces on one another to fabricate a multilayer base;
cutting the multilayer base to fabricate a base component;
firing the base component; and
forming an external electrode on the fired base component.
